(19) United States
(12) Patent Application Publication
(10) Pub. No.: US 2023/0420659 A1
(43) Pub. Date: Dec. 28, 2023

(54) NEGATIVE ELECTRODE PLATE AND BATTERY

(71) Applicant: ZHUHAI COSMX BATTERY CO., LTD., Zhuhai (CN)

(72) Inventors: Hanjiao XU, Zhuhai (CN); Ruinian LI, Zhuhai (CN); Feng WANG, Zhuhai (CN); Suli LI, Zhuhai (CN)

(73) Assignee: ZHUHAI COSMX BATTERY CO., LTD., Zhuhai (CN)

(21) Appl. No.: 18/335,734

(22) Filed: Jun. 15, 2023

(30) Foreign Application Priority Data
Jun. 28, 2022 (CN) 202210749746.7

(51) Int. Cl. H01M 4/36; H01M 4/133; H01M 4/134; H01M 4/587; H01M 4/38; H01M 4/62; H01M 4/48; H01M 4/131; H01M 4/52; H01M 4/136

(52) U.S. Cl. CPC H01M 4/366; H01M 4/133; H01M 4/134; H01M 4/587; H01M 4/386; H01M 4/625; H01M 4/622; H01M 4/483; H01M 4/131; H01M 4/523; H01M 4/136; H01M 2004/027

(57) ABSTRACT

Disclosed are a negative electrode plate and a battery, the negative electrode plate includes a current collector and an active layer; the active layer is positioned on two opposite surfaces of the current collector; the active layer includes a first functional material; the content of the first functional material increases in a direction away from the current collector; the content of the first functional material in a first region of the active layer is less than the content of the first functional material in a second region of the active layer; the vertical distance from the first region to the current collector is less than the vertical distance from the second region to the current collector; and the first functional material includes at least one of a silicon-based material, a metal oxide, or a metal sulfide. The energy density and dynamics of the negative electrode plate are improved.

### CROSS-REFERENCE TO RELATED APPLICATIONS

The present application claims priority to Chinese Patent Application No. 202210749746.7, filed on Jun. 28, 2022, which is hereby incorporated by reference in its entirety.

### TECHNICAL FIELD

The present disclosure relates to the technical field of batteries, and in particular, to a negative electrode plate and a battery.

### BACKGROUND

Lithium batteries are widely used in the field of consumer electronics, new energy vehicles, military aerospace, and the like. With the progress of technology, higher requirements are provided for the charging capacity and energy density of lithium-ion batteries.

In prior arts, the energy density of a battery is generally improved by increasing the thickness of a electrode plate; but the migration distance of the lithium-ion is increased due to the increase of the thickness of the electrode plate; or, the energy density of the battery is improved by increasing the compaction density of the electrode plate; but the increase of the compaction density results in a decrease of the porosity of the electrode plate. The increase in migration distance or the decrease of porosity may lead to a decrease in the charging capability of the lithium-ion battery.

It can be seen that, in the prior art, there is a problem of the poor performance of the battery.

### SUMMARY

An embodiment of the present disclosure provides a negative electrode plate and a battery, to solve the problem of poor performance of a battery in the prior art.

An embodiment of the present disclosure provides a negative electrode plate, including a current collector and an active layer, where: the active layer is positioned on two opposite surfaces of the current collector; the active layer includes a first functional material; the content of the first functional material increases in a direction away from the current collector; the content of the first functional material in a first region of the active layer is less than the content of the first functional material in a second region of the active layer; the vertical distance from the first region to the current collector is less than the vertical distance from the second region to the current collector; and the first functional material includes at least one of a silicon-based material, a metal oxide, or a metal sulfide.

Optionally, the silicon-based material includes at least one of silicon particles, silicon carbon composite, silicon oxide, or silicon alloy.

Optionally, the metal oxide includes at least one of tin oxide, nickel oxide, cobalt oxide, antimony oxide, or bismuth oxide.

Optionally, the metal sulfide includes at least one of tin sulfide, nickel sulfide, cobalt sulfide, antimony sulfide, or bismuth sulfide.

Optionally, the active layer further includes a second functional material, the content of the second functional material increases in a direction away from the current collector; the content of the second functional material in the first region is less than the content of the second functional material in the second region.

Optionally, the conductivity of the second functional material is greater than that of any other conductive agent in the active layer except for the second functional material.

Optionally, the second functional material includes at least one of carbon nanotube, graphene, gold fiber, or silver fiber, and the conductive agent except for the second functional material includes at least one of conductive carbon black, acetylene black, Ketjen black, conductive graphite, conductive carbon fiber, metal powder, or carbon fiber.

Optionally, the active layer at least includes a first sub-active layer, a second sub-active layer, and a third sub-active layer; the first sub-active layer is positioned on a side surface of the current collector; the second sub-active layer is positioned on the first sub-active layer; and the third sub-active layer is disposed on the second sub-active layer; and the content of the first functional material increases in a direction from the first sub-active layer to the third sub-active layer.

Optionally, the active layer further includes a second functional material; and the content of the second functional material increases in a direction from the first sub-active layer to the third sub-active layer.

Optionally, the first sub-active layer includes a first active substance, a first conductive agent, and a first binder; and a mass percentage range ratio between the first active substance, the first conductive agent and the first binder is (70 wt %-99 wt %):(0.5 wt %-15 wt %):(0.5 wt %-15 wt %).

Optionally, the second sub-active layer includes a second active substance, a second conductive agent, and a second binder; and a mass percentage range ratio between the second active substance, the second conductive agent and the second binder is (70 wt %-99 wt %):(0.5 wt %-15 wt %):(0.5 wt %-15 wt %).

Optionally, the second active substance includes the first functional material accounting for A₁%; and the second conductive agent includes the second functional material accounting for A₂%.

Optionally, the first functional material accounting for A₁% is 0 wt % to 30 wt % at least one of a silicon-based material, and the second functional material accounting for A₂% is 0 wt % to the carbon nanotube.

Optionally, the second active substance includes a carbon-based silicon-doped material; and the second conductive agent includes the second functional material and at least one of conductive carbon black, acetylene black, Ketjen black, conductive graphite, conductive carbon fiber, metal powder, or carbon fiber.

Optionally, the second active substance includes silicon-doped graphite; the second conductive agent includes conductive carbon black and carbon nanotubes; and the second binder includes styrene-butadiene latex.

Optionally, the third sub-active layer includes a third active substance, a third conductive agent, and a third binder; and a mass percentage range ratio between the third active substance, the third conductive agent and the third binder is (70 wt %-99 wt %):(0.5 wt %-15 wt %):(0.5 wt %-15 wt %).

Optionally, the third active substance includes the first functional material accounting for B₁%; the third conductive agent includes the second functional material accounting for B₂%; B₁ is greater than A₁; and B₂ is greater than A₂.

Optionally, the first functional material accounting for B₁% is 0 wt % to 30 wt % at least one of a silicon-based material, a metal oxide, or a metal sulfide, where B₁ is greater than A₁, and is excluded; and the second functional material accounting for B₂% is 0 wt % to 15 wt % carbon nanotubes, where 0 wt % is excluded.

Optionally, the third active substance includes a carbon-based silicon-doped material; and the third conductive agent includes the second functional material and at least one of conductive carbon black, acetylene black, Ketjen black, conductive graphite, conductive carbon fiber, metal powder, or carbon fiber.

Optionally, the third active substance includes silicon-doped graphite; the third conductive agent includes conductive carbon black and carbon nanotubes; and the third binder includes styrene-butadiene latex.

Optionally, the first sub-active layer, the second sub-active layer, and the third sub-active layer have the same thickness.

Optionally, the thickness of any layer of the second sub-active layer and the third sub-active layer is less than the thickness of the first sub-active layer.

Optionally, the thickness of the third sub-active layer is less than the thickness of the second sub-active layer, and the thickness of the second sub-active layer is less than the thickness of the first sub-active layer.

An embodiment of the present disclosure further provides a battery, including the negative electrode plate described above.

In the embodiments of the present disclosure, a first functional material is added to an active layer, which has a greater expansion rate and a higher lithium intercalation/deintercalation capacity, thereby increasing the porosity of the active layer while reducing the negative effect on the energy density of the negative electrode plate. The increase of the porosity improves the migration rate of lithium ions in the active layer, thereby improving energy density and dynamics of the negative electrode plate, and further improving the fast charging performance of a battery.

Moreover, in a direction away from a current collector, the content of the first functional material increases, so that the content of the first functional material in the first region is less than that of the first functional material in the second region to form a concentration gradient difference, thereby enhancing the mass transfer capability of the active layer; and the first functional material with a lower content is provided in the first region close to the current collector, so as to reduce the loss of electrical contact between the current collector and the active layer.

### BRIEF DESCRIPTION OF THE DRAWINGS

In order to more clearly illustrate the technical solutions of the embodiments of the present disclosure, the drawings used in the embodiments or the prior art are briefly described below. Apparently, the drawings in the following description are merely some embodiments of the present disclosure, and for a person of ordinary skill in the art, other drawings may also be obtained based on these drawings without creative efforts.

FIG. 1 is a schematic structural diagram of the negative electrode plate provided by an embodiment of the present disclosure.

FIG. 2 is a second schematic structural diagram of the negative electrode plate provided by an embodiment of the present disclosure.

FIG. 3 is a third schematic structural diagram of the negative electrode plate provided by an embodiment of the present disclosure.

FIG. 4 is a schematic structural diagram of the positive electrode plate provided by an embodiment of the present disclosure.

FIG. 5 is a fourth schematic structural diagram of the negative electrode plate provided by an embodiment of the present disclosure.

FIG. 6 is a fifth schematic structural diagram of the negative electrode plate provided by an embodiment of the present disclosure.

### DETAILED DESCRIPTION OF THE EMBODIMENTS

The technical solutions in the embodiments of the present disclosure will be clearly and completely described below concerning the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

The terms “first”, “second” and the like in the specification and claims of the present disclosure are used to distinguish similar objects, and are not used to describe a particular order or sequence. It should be understood that the structures used in this way may be interchanged under appropriate circumstances, so that the embodiments of the present disclosure may be implemented in an order other than those illustrated or described herein; and objects distinguished by “first”, “second” and the like are generally of one class and do not define the number of objects, for example, the first object may be one or more. In addition, in the specification and claims, “and/or” means at least one of the connected objects; and the character “/” generally indicates that the associated objects are in an “or” relationship.

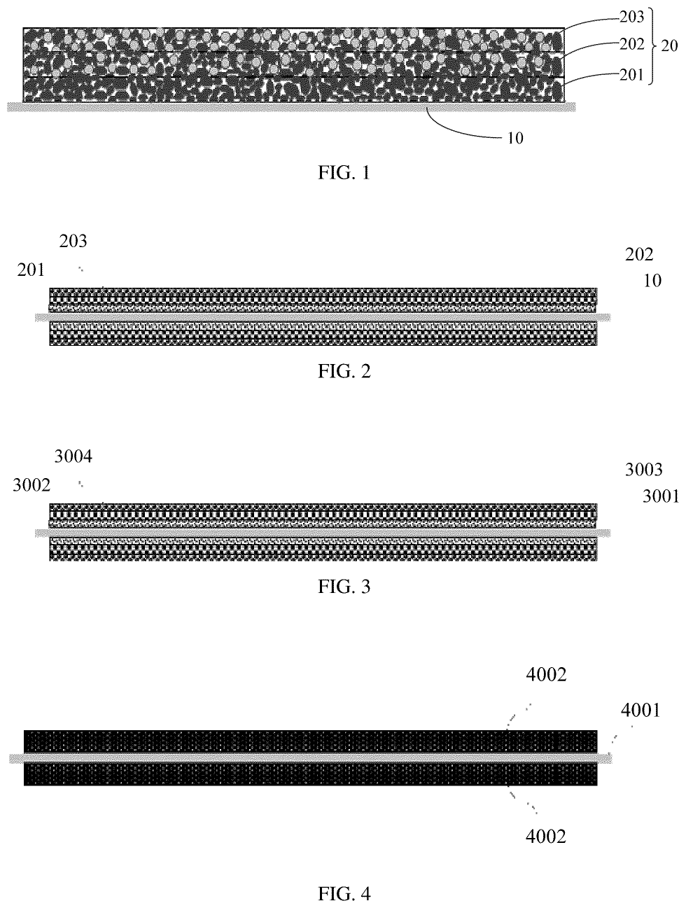

An embodiment of the disclosure provides a negative electrode plate, as shown in FIG. 1 and FIG. 2, which includes a current collector 10 and an active layer 20. The active layers 20 are positioned on two opposite side surfaces of the current collector 10. The active layer 20 includes a first functional material; the content of the first functional material increases in a direction away from the current collector 10, such that the content of the first functional material in the first region of the active layer 20 is less than the content of the first functional material in a second region of the active layer 20; the vertical distance from the first region to the current collector 10 is less than the vertical distance from the second region to the current collector 10; and the first functional material includes at least one of a silicon-based materials, a metal oxide, or a metal sulfide.

In this embodiment, compared with other active substances in the active layer 20 (for example, artificial graphite, natural graphite, soft carbon, hard carbon, and the like), the first functional material added in the active layer 20, which consists of at least one of a silicon-based materials, a metal oxide, or a metal sulfide, has a greater expansion rate and a higher lithium intercalation/deintercalation capacity, thereby increasing the porosity of the active layer 20 while reducing the negative effect on the energy density of the negative electrode plate. The increase of the porosity improves the migration rate of the lithium ions in the active layer 20, thereby improving the energy density and dynamics of the negative electrode plate, and further improving the fast charging performance of the battery.

Moreover, in a direction away from the current collector 10, the content of the first functional material increases, such that the content of the first functional material in the first region is less than that in the second region to form a concentration gradient difference, thereby enhancing the mass transfer capability of the active layer; and the first functional material with a lower content is provided in the first region close to the current collector 10, so as to reduce the loss of electrical contact between the current collector 10 and the active layer 20.

Optionally, the median particle size Dv50 of the first functional material in the first region is equal to the median particle size Dv50 of the first functional material in the second region.

In this embodiment, the median particle size Dv50 is the particle size at the 50th percentile in a cumulative particle size distribution curve, measured by a Laser Scattering Particle Size Analyzer. The average particle diameter Dv50 of the first functional material in the first region and the second region of the active layer 20 are the same within error range; in other words, the difference between the first functional material of the first region and that of the second region lies in the content difference. During the preparation of the active layer 20, the step of screening the particle size of the first functional material is omitted, thereby simplifying the process and improving the production efficiency.

Optionally, the active layer 20 further includes a second functional material; the content of the second functional material increases in a direction away from the current collector 10, such that the content of the second functional material in the first region is less than the content of the second functional material in the second region.

In this embodiment, by adding the second functional material to the active layer 20, the content of the second functional material is increased synchronously with the content of the first functional material, so as to compensate for the effect of the addition of the silicon-based material on the conductive performance of the active layer 20, thereby improving the conductivity of the negative electrode plate.

Where, the conductivity of the second functional material is greater than that of any other conductive agent in the active layer 20 except for the second functional material. For example, the second functional material may include at least one of a conductive carbon tube (or a carbon nanotube), graphene, gold fiber, or silver fiber. Compared with any other conductive agent (such as conductive carbon black, acetylene black, Ketjen black, conductive graphite, conductive carbon fiber, metal powder, or carbon fiber) in the active layer 20, the second functional material including the conductive carbon tube and/or graphene has a larger contact area, so as to form a linear or planar conductive network, thereby improving the conductivity; and meanwhile, the second functional material cooperating with the first functional material who has a greater expansion rate and higher lithium intercalation/deintercalation capability, improves the migration rate of the lithium ions in the active layer 20, thereby improving the fast charging performance of the battery.

The silicon-based material may include at least one of silicon particles, silicon carbide, silicon oxide, or silicon alloy.

The metal oxide may include at least one of tin oxide, nickel oxide, cobalt oxide, antimony oxide, or bismuth oxide.

The metal sulfide may include at least one of tin sulfide, nickel sulfide, cobalt sulfide, antimony sulfide, or bismuth sulfide.

Optionally, the active layer 20 at least includes a first sub-active layer 201, a second sub-active layer 202, and a third sub-active layer 203, where: the first sub-active layer 201 is positioned on a side surface of the current collector 10; the second sub-active layer 202 is positioned on the first sub-active layer 201; and the third sub-active layer 203 is positioned on the second sub-active layer 202; and the content of the first functional material increases in a direction from the first sub-active layer 201 to the third sub-active layer 203.

In some optional embodiments, argon ion grinding is performed on the thickness direction of the negative electrode plate; and it can be observed through a scanning electron microscope SEM that the cross section of the negative electrode plate provided by the present disclosure includes a current collector 10; the active layers 20 are respectively coated on two opposite side surfaces of the current collector 10; and the active layer 20 includes a first sub-active layer 201, a second sub-active layer 202, and a third sub-active layer 203. the first functional materials with different concentration gradients may be provided in the first sub-active layer 201 to the third sub-active layer 203.

In this way, by adding the first functional material with a greater expansion rate and higher lithium intercalation/deintercalation capacity into the active layer 20, the energy density of the negative electrode plate increases while the thickness of the active layer 20 remain the same; meanwhile, compared with other active substances in the active layer 20, the silicon-based material has a greater expansion rate, thereby increasing the porosity of the active layer 20; and the increase of the porosity improves the migration rate of the lithium ions in the active layer 20, thereby improving the energy density and conductivity of the negative electrode plate, and further improving the performance of the battery.

Moreover, the content of the first functional material increases in the direction from the first sub-active layer 201 to the third sub-active layer 203 to form a concentration gradient difference, thereby enhancing the mass transfer capability of the active layer 20; and the first functional material with a lower content is provided in the first sub-active layer 201, so as to reduce the loss of electrical contact between the current collector 10 and the active layer 20.

Where, the active layer 20 further includes the second functional material; and the content of the second functional material increases in a direction from the first sub-active layer 201 to the third sub-active layer 203.

By adding the second functional material to the active layer 20, the second functional material has a higher conductivity than any other conductive agent in the active layer 20; and the content of the second functional material is increased synchronously with the content of the first functional material, so as to compensate for the effect of the silicon-based material on the conductive performance in each sub-active layer, thereby improving the conductivity of the negative electrode plate.

It should be noted that, according to the actual preparation process, the active layer 20 may be set into more sub-active layers, so that the contents of the first functional material and the second functional material are gradually increased in the direction away from the current collector and the same technical effect may also be achieved, which is not repeated here for avoiding repetition.

Optionally, the first sub-active layer 201 does not include the first functional material and the second functional material.

In some other alternative embodiments, the expansion of the silicon-based material may loosen the electrode plate, thereby improving the transmission performance of ions. However, what really needs to be loosened is the portion of the active layer 20 away from the current collector that is, it is the third sub-active layer 203 that really needs to be loosened. the first functional material is not provided in the first sub-active layer 201, so as to reduce the loss of electrical contact between the current collector 10 and the active layer 20. From the second sub-active layer 202 to the third sub-active layer 203, the concentration gradient of the first functional material and the second functional material capable of improving conductivity are increased; and the fast charging performance of the battery is improved without losing the side electrical contact of the current collector 10.

It should be noted that during the preparation process of the negative electrode plate, part of the first functional material and part of the second functional material in the second sub-active layer 202 may be transferred to the first sub-active layer 201 through the rolling-process, so that the substance in the first sub-active layer 201 is changed. In other words, the first sub-active layer 201 contains a small amount of the first functional material and the second functional material derived from the second sub-active layer 202, which can also achieve the same technical effect, and details are not described herein again.

Optionally, the first sub-active layer 201, the second sub-active layer 202, and the third sub-active layer 203 have the same thickness.

Optionally, the thickness of any layer of the second sub-active layer 202 and the third sub-active layer 230 is less than the thickness of the first sub-active layer 201.

Optionally, the thickness of the third sub-active layer 203 is less than the thickness of the second sub-active layer 202, and the thickness of the second sub-active layer 202 is less than the thickness of the first sub-active layer 201.

In some alternative embodiments, the first sub-active layer 201, the second sub-active layer 202, and the third sub-active layer 203 have the same thickness. the first functional material has a greater expansion rate and a higher lithium intercalation/deintercalation capability, so the negative electrode plate has a higher energy density when the thickness of the active layer 20 is the same. In other words, the active layer 20 added with the first functional material has the characteristic of high gram capacity; and the design thickness of the negative electrode plate may be reduced under the condition that the energy density of the negative electrode plate is the same. The thicknesses of the first sub-active layer 201, the second sub-active layer 202, and the third sub-active layer 203 are the same, which facilitates the adjustment of the content of the first functional material in the first sub-active layer 201, the second sub-active layer 202, and the third sub-active layer 203, so that the content of the first functional material increases in the direction from the first sub-active layer 201 to the third sub-active layer 203 to form a concentration gradient difference, enhancing the mass transfer capability of the active layer 20, and improving the preparation efficiency of the negative electrode plate.

In some other alternative embodiments, the thickness of any layer of the second sub-active layer 202 and the third sub-active layer 203 is less than the thickness of the first sub-active layer 201. the first functional material may not be provided in the first sub-active layer 201, so as to reduce the loss of electrical contact between the current collector 10 and the active layer 20; the second sub-active layer 202 and the third sub-active layer 203 provided with the first functional material have the characteristic of high gram capacity; and under the condition that the energy density is the same, the thickness of any layer of the second sub-active layer 202 and the third sub-active layer 203 may be less than the thickness of the first sub-active layer 201, thereby reducing the design thickness of the negative electrode plate, increasing the proportion of the active substance in the negative electrode plate, and improving the performance of the battery.

Further, the content of the first functional material in the third sub-active layer 203 is greater than that in the second sub-active layer 202; and in the case that the energy density of the second sub-active layer 202 and the third sub-active layer 203 are the same, the thickness of the third sub-active layer 203 may be less than the thickness of the second sub-active layer 202. Similarly, the thickness of the second sub-active layer 202 may be less than the thickness of the first sub-active layer 201, thereby further reducing the design thickness of the negative electrode plate, increasing the proportion of the active substance in the negative electrode plate, and improving the battery performance.

The preparation process of the first sub-active layer 201 may be expressed as follows:

Optionally, the first sub-active layer 201 includes a first active substance, a first conductive agent, and a first binder; and a mass percentage range ratio between the first active substance, the first conductive agent, and the first binder is (70 wt %-99 wt %):(0.5 wt %-15 wt %):(0.5 wt %-15 wt %).

In the present disclosure, examples of “70 wt %-99 wt %” could be 70 wt %, 72 wt %, 74 wt %, 76 wt %, 78 wt %, 80 wt %, 82 wt %, 84 wt %, 86 wt %, 88 wt %, 90 wt %, 92 wt %, 94 wt %, 96 wt %, 98 wt %, 99 wt %; and, examples of “0.5 wt %-15 wt %” could be 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt %, 0.5 wt %.

The first active substance, the first conductive agent and the first binder are configured according to a mass percentage range ratio of (70 wt %-99 wt %):(0.5 wt %-15 wt %):(0.5 wt %-15 wt %); a solvent is added for stirring to prepare a first slurry; and the solid content of the first slurry may be 40 wt %-45 wt %. The first slurry is laid on two opposite surfaces of the current collector 10, respectively, to form a first sub-active layer 201.

The first active substance may include a carbon-based material, such as graphite, mesocarbon micro-bead, and the like.

The first conductive agent may include at least one of conductive carbon black, acetylene black, Ketj en black, conductive graphite, conductive carbon fiber, metal powder, carbon fiber, and the like.

The first binder may include at least one of styrene-butadiene latex, polyacrylic acid, polyacrylate, sodium polyacrylate, polyvinylidene fluoride, polytetrafluoroethylene, lithium polyacrylate, and the like.

For example, the first active substance is graphite; the first conductive agent is conductive carbon black; and the first binder is styrene-butadiene latex. Graphite, conductive carbon black, and styrene butadiene latex are configured according to a mass percentage range ratio of 95.5 wt %:1.5 wt %:3 wt %; the solvent is added for stirring to prepare the first slurry; and the solid content of the first slurry may be 40 w %.

The preparation process of the second sub-active layer 202 may be expressed as follows:

Optionally, the second sub-active layer 202 includes a second active substance, a second conductive agent, and a second binder; and a mass percentage range ratio between the second active substance, the second conductive agent and the second binder is (70 wt %-99 wt %):(0.5 wt %-15 wt %):(0.5 wt %-15 wt %).

The second active substance includes the first functional material accounting for A₁%; and the second conductive agent includes the second functional material accounting for A₂%.

The second active substance including A₁% first functional material, the second conductive agent including A₂% second functional material, and the second binder are configured according to a mass percentage range ratio of (70 wt %-99 wt %):(0.5 wt %-15 wt %):(0.5 wt %-15 wt %); a solvent is added for stirring to prepare a second slurry; and the solid content of the second slurry may be 40 wt %-45 wt %. Where, A₁% first functional material may be 0 wt % to 30 wt % at least one of a silicon-based material, a metal oxide or a metal sulfide; and A₂% second functional material may be 0 wt % to 15 wt % the carbon nanotube. The second functional material may account for 0.1 wt % to 0.5 wt % (for example, 0.1 wt %, 0.2 wt %, 0.3 wt %, 0.4 wt %, 0.5 wt %) of the second sub-active layer 202. The second slurry is laid on the surface of the first sub-active layer 201 to form the second sub-active layer 202.

In the present disclosure, examples of “0 wt % to 30 wt %” could be 0 wt %, 2 wt %, 5 wt %, 8 wt %, 10 wt %, 12 wt %, 15 wt %, 18 wt %, 20 wt %, 22 wt %, 25 wt %, 28 wt %, 30 wt %; examples of “0 wt % to 15 wt %” could be 0 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %.

The second active substance may include a carbon-based silicon-doped material, which is a carbon-based material (belonging to the active material) doped with a silicon-based material (belonging to the first functional material).

The second conductive agent may include the second functional material and at least one of conductive carbon black, acetylene black, Ketjen black, conductive graphite, conductive carbon fiber, metal powder, carbon fiber, and the like.

The second binder may include at least one of styrene-butadiene latex, polyacrylic acid, polyacrylate, sodium polyacrylate, polyvinylidene fluoride, polytetrafluoroethylene, lithium polyacrylate, and the like.

For example, the second active substance includes silicon-doped graphite; the second conductive agent includes conductive carbon black, and carbon nanotubes with better conductivity are added; and the second binder includes styrene-butadiene latex. silicon-doped graphite, conductive carbon black, carbon nanotubes and styrene-butadiene latex were configured according to a mass percentage ratio of 95.5 wt %:1.2 wt %:0.3 wt %:3 wt %; a solvent is added for stirring to prepare the second slurry; and the solid content of a second slurry may be 40 wt %. The second active substance includes 6% of the silicon-based material; that is, the percentage value of the carbon-based material to the silicon-based material is 94%:6%.

The preparation process of the third sub-active layer 203 may be expressed as follows:

Optionally, the third sub-active layer 203 includes a third active substance, a third conductive agent, and a third binder; and a mass percentage range ratio between the third active substance, the third conductive agent and the third binder is (70 wt %-99 wt %):(0.5 wt %-15 wt %):(0.5 wt %-15 wt %).

The third active substance includes the first functional material accounting for B₁%; the third conductive agent includes the second functional material accounting for B₂%; B₁ is greater than A₁; and B₂ is greater than A₂.

Optionally, B1:A1 is (1.1-8): 1, preferably is (1.5-4): 1. Examples of “1.1-8” could be 1.1, 1.5, 2, 2.5, 3, 3.5, 4, 4.5, 5, 5.5, 6, 6.5, 7, 7.5, 8.

Optionally, B₂:A₂ is (1.2-3): 1, preferably is (1.5-3): 1. Examples of “1.2-3” could be 1.2, 1.5, 1.8, 2, 2.2, 2.5, 2.8, 3.

The third active substance including B₁% first functional material, the third conductive agent including B₂% second functional material, and the third binder are configured according to a mass percentage range ratio of (70 wt %-99 wt %):(0.5 wt %-15 wt %):(0.5 wt %-15 wt %); a solvent is added for stirring to prepare a third slurry; and the solid content of the third slurry may be 40 wt %-45 wt %. Where, B₁% first functional material may be 0 wt % to 30 wt % (where 0 wt % is excluded; such as 0.01 wt % to 30 wt %) at least one of a silicon-based material, a metal oxide, or a metal sulfide; and B₁ is greater than A₁; B₂% second functional material may be 0 wt % to 15 wt % (where 0 wt % is excluded; such as 0.01 wt % to 15 wt %) carbon nanotubes. The second functional material may account for 0.3 wt % to 0.7 wt % (for example, 0.3 wt %, 0.4 wt %, 0.5 wt %, 0.6 wt %, 0.7 wt %) of the third sub-active layer 203. The third slurry is laid on the surface of the second sub-active layer 202 to form a third sub-active layer 203.

The third active substance may include a carbon-based silicon-doped material.

The third conductive agent may include the second functional material and at least one of conductive carbon black, acetylene black, Ketjen black, conductive graphite, conductive carbon fiber, metal powder, carbon fiber, and the like.

The third binder may include at least one of styrene-butadiene latex, polyacrylic acid, polyacrylate, sodium polyacrylate, polyvinylidene fluoride, polytetrafluoroethylene, lithium polyacrylate, and the like.

For example, the third active substance includes silicon-doped graphite; the third conductive agent is conductive carbon black, and carbon nanotubes with better conductivity are added; and the third binder is styrene-butadiene latex. silicon-doped graphite, conductive carbon black, carbon nanotubes and styrene-butadiene latex were configured according to a mass percentage ratio of 95.5 wt %:1 wt %:0.5 wt %:3 wt %; a solvent is added for stirring to prepare a third slurry; and the solid content of the third slurry may be 40 wt %. The third active substance includes 9% of the silicon-based material; that is, the percentage value of the carbon-based material to the silicon-based material is 91%:9%.

An embodiment of the present disclosure further provides a battery, including the negative electrode plate described above.

It may be noted that the implementation of the embodiments of the negative electrode plate is also adapted to the embodiment of the battery; and the same technical effect may be achieved, and details are not described herein again.

Hereinafter, the effect of the battery prepared by using the negative electrode plate provided by the present disclosure is described based on multiple sets of experiments.

### Example 1

Preparing of a negative electrode plate: a copper foil was selected as a negative electrode current collector 3001; graphite was selected as a first active substance; conductive carbon black was selected as a first conductive agent; and styrene-butadiene latex was selected as a first binder. Graphite, conductive carbon black and styrene-butadiene latex were configured according to a mass percentage ratio of 95.5 wt %:1.5 wt %:3 wt %; a solvent is added for stirring to prepare a first slurry; and the solid content of the first slurry was 45%. The first slurry was respectively coated on two opposite surfaces of the negative electrode current collector 3001 by a Coating machine to form the first active layer 3002.

Then, silicon-doped graphite was selected as a second active substance; conductive carbon black was selected as a second conductive agent, and carbon nanotubes with better conductivity were added; and styrene-butadiene latex was selected as a second binder. silicon-doped graphite, conductive carbon black, carbon nanotubes (CNTs) and styrene-butadiene latex were configured according to a mass percentage ratio of 95.5 wt %:1.2 wt %:0.3 wt %:3 wt %; a solvent was added for stirring to prepare a second slurry; and the solid content of the second slurry was 45%. The silicon-doped graphite includes 6% of the silicon-based material silicon; that is, the percentage value of graphite and the silicon-based material in the silicon-doped graphite was 94%: 6%. The second slurry was respectively coated on the surfaces of the first active layer 3002 by a Coating machine to form the second active layer 3003. Compared with the first active layer 3002, the second active layer 3003 was added with the silicon-based material and the carbon nanotubes with better conductivity.

Then, silicon-doped graphite was selected as a third active substance; conductive carbon black was selected as a third conductive agent, and carbon nanotubes with better conductivity were added; and styrene-butadiene latex was selected as a third binder. silicon-doped graphite, conductive carbon black, carbon nanotubes and styrene-butadiene latex were configured according to a mass percentage ratio of 95.5 wt %:1 wt %:0.5 wt %:3 wt %; a solvent is added for stirring to prepare a third slurry; and the solid content of the third slurry was 45%. The silicon-doped graphite includes 9% of the silicon-based material, that is, the percentage value of graphite and the silicon-based material in the silicon-doped graphite is 91%:9%. The third slurry was respectively coated on the surfaces of the second active layer 3003 by a Coating machine to form the third active layer 3004. Compared with the second active layer 3003, the third active layer 3004 was further added with the silicon-based material and the carbon nanotubes with better conductivity; so that in the first active layer 3002 to the third active layer 3004, the concentration gradient of the silicon-based material and the carbon nanotubes capable of improving conductivity was increased.

After drying at 120° C. and rolling, a negative electrode plate was obtained; and its structure is shown in FIG. 3.

Preparation of a positive electrode plate: Lithium cobaltate, acetylene black, and polyvinylidene fluoride were added to a stirring tank according to a mass ratio of 97.2:1.5:1.3; then an N-methylpyrrolidone solvent was added; after stirring, a 200-mesh screen was used; and a positive active slurry was obtained with a solid content of 70 wt % to 75 wt %. The slurry was coated on a positive electrode current collector 4001 (an aluminum foil was used) by using a Coating machine to form a positive active substance layer 4002. After drying at 120° C. and rolling, a positive electrode plate was obtained; and its structure is shown in FIG. 4.

Assembling a battery: the prepared negative electrode plate, the positive electrode plate and a separator were wound together to form a roll core (with a width of 62 mm); the roll core was packaged by using an aluminum-plastic film; after the moisture was removed by baking, an electrolyte was injected; and the battery was obtained after hot pressing.

### Example 2

Preparing of a negative electrode plate: a copper foil was selected as a negative electrode current collector 5001, silicon-doped graphite was selected as a negative active substance, conductive carbon black was selected as a conductive agent, and styrene-butadiene latex was selected as a binder. silicon-doped graphite, conductive carbon black and styrene-butadiene latex were configured according to a mass percentage ratio of 95.5 wt %:1.5 wt %:3 wt %; a solvent was added for stirring to prepare a negative electrode slurry; and the solid content of the negative electrode slurry was 45%. The silicon-doped graphite includes 5% of a silicon-based material; that is, the percentage value of graphite and silicon in the silicon-doped graphite was 95%:5%. The negative electrode slurry was respectively coated on two opposite surfaces of the negative electrode current collector 5001 by a Coating machine to form a negative electrode active layer 5002. The thickness and the surface density of negative electrode plate are the same as in Example 1.

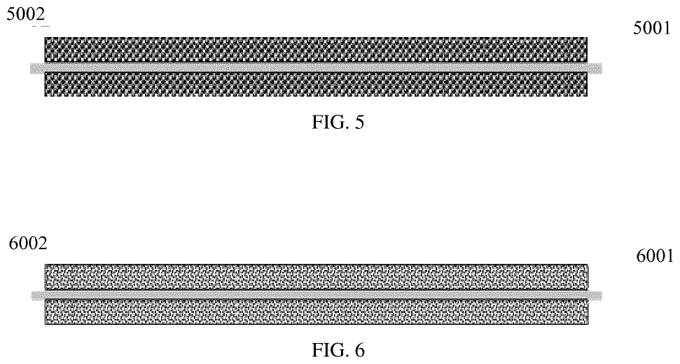

Then, after drying at 120° C. and rolling, a negative electrode plate was obtained; and its structure is shown in FIG. 5.

Preparation of a positive electrode plate: Lithium cobaltate, acetylene black, and polyvinylidene fluoride were added to a stirring tank according to a mass ratio of 97.2:1.5:1.3; then an N-methylpyrrolidone solvent was added; after stirring, a 200-mesh screen was used; and a positive active slurry was obtained with a solid content of 70 wt % to 75 wt %. The slurry was coated on a positive electrode current collector 4001 (aluminum foil is used) by using a Coating machine to form a positive active substance layer 4002. After drying at 120° C. and rolling, a positive electrode positive was obtained; and its structure is shown in FIG. 4.

Assembling a battery: the prepared negative electrode plate, the positive electrode plate and a separator were wound together to form a roll core (with a width of 62 mm); the roll core was packaged by using an aluminum-plastic film; after the moisture was removed by baking, an electrolyte was injected; and the battery was obtained after hot pressing.

### Example Group 3

This set of examples is intended to illustrate the situation in which the composition of the first functional material is changed and the thickness and the surface density of negative electrode plate remain the same as in Example 1.

This set of Examples was carried out with reference to Example 1, except that the selection of a particular substance of the first functional material was changed, respectively:

Example 3a, the silicon-based material Si was replaced by silicon oxide (SiOₓ) with the same parts by weight;

Example 3b, the silicon-based material was replaced by metal tin oxide with the same parts by weight;

Example 3c, the silicon-based material was replaced by nickel oxide with the same parts by weight;

Example 3d, the silicon-based material was replaced by cobalt sulfide with the same parts by weight.

### Example Group 4

This set of examples is intended to illustrate the situation in which the content of the first functional material is changed and the thickness and the surface density of negative electrode plate remain the same as in Example 1.

This set of Examples was carried out with reference to Example 1, except that the contents of the first functional material and/or the second functional material were changed, in particular:

Example 4a, the proportion of the silicon-based material was changed, in particular, the silicon-based material accounted for 3% in the silicon-doped graphite of the second active layer, and 12% in the silicon-doped graphite of the second active layer;

Example 4b, the proportion of the silicon-based material was changed, in particular, the silicon-based material accounted for 6.8% in the silicon-doped graphite of the second active layer, and 8.2% in the silicon-doped graphite of the second active layer;

Example 4c, the proportion of the silicon-based material was changed, in particular, the silicon-based material accounted for 2% in the silicon-doped graphite of the second active layer, and 13% in the silicon-doped graphite of the second active layer.

### Example Group 5

This set of examples is intended to illustrate the situation in which the content and/or the composition of the second functional material is changed and the thickness and the surface density of negative electrode plate remain the same as in Example 1.

Example 5a, this example was carried out with reference to Example 2, except that the negative electrode slurry was prepared by the following method: silicon-doped graphite was selected as a negative active substance; conductive carbon black was selected as a conductive agent, and carbon nanotubes with better conductivity were added; and styrene-butadiene latex was selected as a second binder. silicon-doped graphite, conductive carbon black, carbon nanotubes (CNTs) and styrene-butadiene latex were configured according to a mass percentage ratio of 95.5 wt %:1.2 wt %:0.3 wt %:3 wt %; a solvent was added for stirring to prepare a second slurry.

Example 5b, this example was carried out with reference to Example 5a, except that the carbon nanotubes was replaced by graphene with the same parts by weight.

### Comparative Example 1

Preparing of a negative electrode plate: preparing to form a slurry; the slurry was composed of negative electrode active substance graphite; the slurry was composed of 95.5 wt % of graphite, 1.5 wt % of conductive carbon black and 3 wt % of styrene-butadiene latex; and the solid content of the slurry was 45 wt %. The slurry was coated on a negative electrode current collector 6001 (a copper foil was used) by using a Coating machine to form a negative active substance layer 4002. After drying at 120° C. and rolling, a negative electrode plate was obtained; and its structure is shown in FIG. 6.

Preparation of a positive electrode plate: Lithium cobaltate, acetylene black, and polyvinylidene fluoride were added to a stirring tank according to a mass ratio of 97.2:1.5:1.3; then an N-methylpyrrolidone solvent was added; after stirring, a 200-mesh screen was used; and a positive active slurry was obtained with a solid content of 70 wt % to 75 wt %. The slurry was coated on a positive electrode current collector 4001 (an aluminum foil was used) by using a Coating machine to form a positive active substance layer 4002. After drying at 120° C. and rolling, a positive electrode plate was obtained; and its structure is shown in FIG. 4.

Assembling a battery: the prepared negative electrode plate, the positive electrode plate and a separator were wound together to form a roll core (with a width of 62 mm); the roll core was packaged by using an aluminum-plastic film; after the moisture was removed by baking, an electrolyte was injected; and the battery was obtained after hot pressing.

### Comparative Example 2

Preparing of a negative electrode plate: a copper foil was selected as a negative current collector; a “third slurry” was prepared with reference to Example 1, and was coated on the surface of the negative current collector to form a first layer, where the parameters such as the thickness of the first layer were set with reference to the third active layer in Example 1; a “second slurry” was prepared with reference to Example 1, and was coated on the surface of the first layer to form a second layer, where the parameters such as the thickness of the second layer were set with reference to the second active layer in Example 1; and, a “first slurry” was prepared with reference to Example 1, and was coated on the surface of the second layer to form a third layer, where the parameters such as the thickness of the third layer were set with reference to the first active layer in Example 1.

The battery was assembled with reference to Example 1.

That is, the difference between this Comparative Example 2 and Example 1 is that the first active layer, the second active layer, and the third active layer were arranged in reverse order.

The related parameters in Example 1, Example 2 and Comparative Example 1 are shown in Table 1 below.

TABLE 1

| | | The total | The | The surface |
|---|---|---|---|---|
| | | amount of first | thickness of | density of |
| | | functional material | negative | negative |
| | Structure of electrode | doped in the | electrode | electrode plate |
| | plate | electrode plate | plate (mm) | mg/cm² |
| Example 1 | The gradient of silicon | 5% | 110 | 7.4 |
| | and CNTs contents | | | |
| | increase in a direction | | | |
| | away from the current | | | |
| | collector | | | |
| Example 2 | Uniformly silicon-doped | 5% | 110 | 7.4 |
| | in the electrode plate | | | |
| Example 3a | The gradient of first | 5% | 110 | 7.4 |
| | functional material and | | | |
| | CNTs contents increase | | | |
| | in a direction away from | | | |
| | the current collector | | | |
| Example 3b | The gradient of first | 5% | 110 | 7.4 |
| | functional material and | | | |
| | CNTs contents increase | | | |
| | in a direction away from | | | |
| | the current collector | | | |
| Example 3c | The gradient of first | 5% | 110 | 7.4 |
| | functional material and | | | |
| | CNTs contents increase | | | |
| | in a direction away from | | | |
| | the current collector | | | |
| Example 3d | The gradient of first | 5% | 110 | 7.4 |
| | functional material and | | | |
| | CNTs contents increase | | | |
| | in a direction away from | | | |
| | the current collector | | | |
| Example 4a | The gradient of silicon | 5% | 110 | 7.4 |
| | and CNTs contents | | | |
| | increase in a direction | | | |
| | away from the current | | | |
| | collector | | | |
| Example 4b | The gradient of silicon | 5% | 110 | 7.4 |
| | and CNTs contents | | | |
| | increase in a direction | | | |
| | away from the current | | | |
| | collector | | | |
| Example 4c | The gradient of silicon | 5% | 110 | 7.4 |
| | and CNTs contents | | | |
| | increase in a direction | | | |
| | away from the current | | | |
| | collector | | | |
| Example 5a | Uniformly silicon-doped | 5% | 110 | 7.4 |
| | and CNTs-doped in the | | | |
| | electrode plate | | | |
| Example 5b | Uniformly silicon-doped | 5% | 110 | 7.4 |
| | and CNTs-doped in the | | | |
| | electrode plate | | | |
| Comparative | Non silicon-doped | / | 117.76 | 7.4 |
| Example 1 | (surface density design | | | |
| | is consistent) | | | |
| Comparative | The gradient of silicon | 5% | 110 | 7.4 |
| Example 2 | content decreases in a | | | |
| | direction away from the | | | |
| | current collector | | | |

The batteries prepared in Example 1, Example 2 and Comparative Example 1 were tested for lithium precipitation rate. The test process included: at 25° C., the lithium-ion battery was charged to 4.48 V at a charge rate of 3 C in a constant-current charging manner, then charged in 4.48V constant-voltage charging manner until a current fell to 0.05 C, stand for 2 min, then discharged to 3 V at a charge rate of 1 C in a constant-current discharging manner, stand for 2 min; and this was one charge-discharge cycle. After the lithium-ion battery underwent 10 charge-discharge cycles, the lithium-ion battery was disassembled to obtain the electrode assembly. The electrode assembly was spread out flat, and if lithium precipitation was founded in any area greater than 2 mm² in the negative electrode plate, it is determined that the negative electrode plate had lithium precipitation. The lithium precipitation area size and the lithium precipitation thickness indicate the severity of lithium precipitation. The test results are shown in Table 2 below.

TABLE 2

| | | | | Lithium |
|---|---|---|---|---|
| | | | 3 C constant- | precipitation |
| | | Capacity | current | rate at 3 C |
| | Structure of electrode | density | time max | constant-current |
| | plate | (Wh/L) | (min) | for 10 min |
| Example 1 | The gradient of silicon | 723 | 12 | No lithium |
| | and CNTs contents | | | precipitation |
| | increase in a direction | | | |
| | away from the current | | | |
| | collector | | | |
| Example 2 | Uniformly silicon- | 724 | 10 | Slight lithium |
| | doped in the electrode | | | precipitation |
| | plate | | | |
| Example 3a | The gradient of first | 722 | 11.8 | No lithium |
| | functional material and | | | precipitation |
| | CNTs contents increase | | | |
| | in a direction away | | | |
| | from the current | | | |
| | collector | | | |
| Example 3b | The gradient of first | 720.6 | 11.5 | No lithium |
| | functional material and | | | precipitation |
| | CNTs contents increase | | | |
| | in a direction away | | | |
| | from the current | | | |
| | collector | | | |
| Example 3c | The gradient of first | 721.1 | 11.7 | No lithium |
| | functional material and | | | precipitation |
| | CNTs contents increase | | | |
| | in a direction away | | | |
| | from the current | | | |
| | collector | | | |
| Example 3d | The gradient of first | 721.8 | 11.5 | No lithium |
| | functional material and | | | precipitation |
| | CNTs contents increase | | | |
| | in a direction away | | | |
| | from the current | | | |
| | collector | | | |
| Example 4a | The gradient of silicon | 724 | 12 | No lithium |
| | and CNTs contents | | | precipitation |
| | increase in a direction | | | |
| | away from the current | | | |
| | collector | | | |
| Example 4b | The gradient of silicon | 724 | 10.5 | No lithium |
| | and CNTs contents | | | precipitation |
| | increase in a direction | | | |
| | away from the current | | | |
| | collector | | | |
| Example 4c | The gradient of silicon | 723.6 | 11 | No lithium |
| | and CNTs contents | | | precipitation |
| | increase in a direction | | | |
| | away from the current | | | |
| | collector | | | |
| Example 5a | Uniformly silicon- | 723.8 | 11 | No lithium |
| | doped and CNTs-doped | | | precipitation |
| | in the electrode plate | | | |
| Example 5b | Uniformly silicon- | 723 | 10.8 | No lithium |
| | doped and CNTs-doped | | | precipitation |
| | in the electrode plate | | | |
| Comparative | Non silicon-doped | 720 | 8 | Serious lithium |
| Example 1 | (surface density design | | | precipitation |
| | is consistent) | | | |
| Comparative | The gradient of silicon | 723 | 6 | Serious lithium |
| Example 2 | content decreases in a | | | precipitation |
| | direction away from the | | | |
| | current collector | | | |

By comparing Example 2 and Comparative Example 1: the negative electrode plate is thinner due to silicon doping; the transmission distance of lithium ions from the separator to the current collector side is reduced; and the dynamic performance of the battery is improved. The charge conduction capability of the thinner electrode plate from the current collector side to the separator side is better. Therefore, during high-rate charging, the lithium precipitation of the thinner negative electrode plate after silicon doping (Example 2, Example 1) is greatly reduced. Since the fact that the expansion of silicon is slightly larger than that of graphite, a gap may be caused after the silicon-doped electrode plate is charged and discharged for the first time; and the permeation of the electrolyte greatly improves the ion transmission performance, so that the fast charging performance of the battery is improved.

By comparing Example 1 and Example 2: the expansion of silicon particles after silicon doping may loosen the electrode plate and improve the transmission performance of the ions. What really needs to be loosened is the portion of the active layer away from the current collector. Integrally silicon doping (Example 2) results in a loss of electrical contact with the electrode plate portion. Compared with Example 2, in Example 1, a gradient of porosity is formed in the surface layer of the active layer; the fast charging performance of the battery is improved without losing the current side electrical contact of the current collector side; and no lithium precipitation at 3C high rate charging.

With the above-mentioned comparison, the silicon-based material of the first functional material has a greater expansion rate and a higher lithium intercalation/deintercalation capacity, thereby increasing the porosity of the active layer 20 while reducing the negative effect on the energy density of the negative electrode plate. The increase of the porosity improves the migration rate of lithium ions in the active layer 20, thereby improving the energy density and dynamics of the negative electrode plate, and further improving the fast charging performance of a battery.

Moreover, in a direction away from the current collector 10, the content of the first functional material increases, so that the content of the first functional material in the first region is less than that in the second region to form a concentration gradient difference. Due to the design of silicon doping gradient concentration, the effect of gradient porosity ratio design is finally achieved; and the mass transfer capability of the active layer 20 is enhanced. the first functional material with a lower content is provided in the first region close to the current collector 10, so as to reduce the loss of electrical contact between the current collector 10 and the active layer 20, and has a good effect in the design of the high energy density fast charging lithium-ion battery.

It should be noted that, in this context, the terms “comprising”, “including”, or any other variant thereof are intended to cover a non-exclusive inclusion; such that a process, method, item, or apparatus including a series of elements includes not only those elements, but also other elements not explicitly listed, or elements inherent to such the process, method, item, or apparatus. Without more restrictions, the element defined by the statement “including one . . . ” does not exclude the presence of additional identical element in the process, method, item, or apparatus including the element. In addition, it should be noted that, the scope of the method and apparatus in the embodiments of the present discourse is not limited to performing the functions in the order discussed, and may also include performing the functions in a substantially simultaneous manner or an opposite order according to the involved functions; for example, the described method may be performed in a different order that described, and various steps may also be added, omitted, or combined. In addition, features described concerning certain embodiments may be combined in other embodiments.

The embodiments of the present discourse are described above concerning the drawings, but the present discourse is not limited to the specific embodiments described above; and the specific embodiments described above are merely illustrative rather than limiting. A person of ordinary skill in the art may also make many forms without departing from the spirit of the present discourse and the scope of protection of the claims, all of which fall within the protection of the present discourse.

What is claimed is:

1. A negative electrode plate, comprising a current collector and an active layer, wherein:
the active layer is positioned on two opposite surfaces of the current collector;
the active layer comprises a first functional material;
a content of the first functional material increases in a direction away from the current collector; the content of the first functional material in a first region of the active layer is less than the content of the first functional material in a second region of the active layer;
a vertical distance from the first region to the current collector is less than a vertical distance from the second region to the current collector; and
the first functional material comprises at least one of a silicon-based material, a metal oxide, or a metal sulfide.

2. The negative electrode plate according to claim 1, wherein the silicon-based material comprises at least one of silicon particles, silicon carbon composite, silicon oxide, or silicon alloy.

3. The negative electrode plate according to claim 1, wherein the metal oxide comprises at least one of tin oxide, nickel oxide, cobalt oxide, antimony oxide, or bismuth oxide.

4. The negative electrode plate according to claim 1, wherein the metal sulfide comprises at least one of tin sulfide, nickel sulfide, cobalt sulfide, antimony sulfide, or bismuth sulfide.

5. The negative electrode plate according to claim 1, wherein the active layer further comprises a second functional material; a content of the second functional material increases in a direction away from the current collector; and the content of the second functional material in the first region is less than the content of the second functional material in the second region.

6. The negative electrode plate according to claim 5, wherein a conductivity of the second functional material is greater than that of any other conductive agents in the active layer except for the second functional material.

7. The negative electrode plate according to claim 5, wherein the second functional material comprises at least one of carbon nanotube, graphene, gold fiber, or silver fiber, and a conductive agent except for the second functional material comprises at least one of conductive carbon black, acetylene black, Ketjen black, conductive graphite, conductive carbon fiber, metal powder, or carbon fiber.

8. The negative electrode plate according to claim 1, wherein the active layer at least comprises a first sub-active layer, a second sub-active layer, and a third sub-active layer;
the first sub-active layer is positioned on a side surface of the current collector; the second sub-active layer is positioned on the first sub-active layer; the third sub-active layer is positioned on the second sub-active layer; and
the content of the first functional material increases in a direction from the first sub-active layer to the third sub-active layer.

9. The negative electrode plate according to claim 8, wherein the active layer further comprises a second functional material; and a content of the second functional material increases in a direction from the first sub-active layer to the third sub-active layer.

10. The negative electrode plate according to claim 8, wherein the first sub-active layer comprises a first active substance, a first conductive agent, and a first binder; and a mass percentage range ratio between the first active substance, the first conductive agent, and the first binder is (70 wt %-99 wt %):(0.5 wt %-15 wt %):(0.5 wt %-15 wt %).

11. The negative electrode plate according to claim 9, wherein the second sub-active layer comprises a second active substance, a second conductive agent, and a second binder; and a mass percentage range ratio between the second active substance, the second conductive agent and the second binder is (70 wt %-99 wt %):(0.5 wt %-15 wt %):(0.5 wt %-15 wt %);
the second active substance comprises the first functional material accounting for A₁%; and the second conductive agent comprises the second functional material accounting for A₂%.

12. The negative electrode plate according to claim 11, wherein the first functional material accounting for A₁% is 0 wt % to 30 wt % at least one of a silicon-based material, and the second functional material accounting for A₂% is 0 wt % to 15 wt % a carbon nanotube.

13. The negative electrode plate according to claim 11, wherein the second active substance comprises a carbon-based silicon-doped material; and the second conductive agent comprises the second functional material and at least one of conductive carbon black, acetylene black, Ketjen black, conductive graphite, conductive carbon fiber, metal powder, or carbon fiber.

14. The negative electrode plate according to claim 11, wherein the second active substance comprises silicon-doped graphite; the second conductive agent comprises conductive carbon black and carbon nanotubes; and the second binder comprises styrene-butadiene latex.

15. The negative electrode plate according to claim 11, wherein the third sub-active layer comprises a third active substance, a third conductive agent, and a third binder; and a mass percentage range ratio between the third active substance, the third conductive agent and the third binder is (70 wt %-99 wt %):(0.5 wt %-15 wt %):(0.5 wt %-15 wt %);
the third active substance comprises the first functional material accounting for B₁%; the third conductive agent comprises the second functional material accounting for B₂%; B₁ is greater than A₁; and B₂ is greater than A₂.

16. The negative electrode plate according to claim 15, wherein the first functional material accounting for B₁% is 0 wt % to 30 wt % at least one of a silicon-based material, a metal oxide, or a metal sulfide, wherein B₁ is greater than A 1, and 0 wt % is excluded; and the second functional material accounting for B₂% is 0 wt % to 15 wt % carbon nanotubes, wherein 0 wt % is excluded.

17. The negative electrode plate according to claim 15, wherein the third active substance comprises a carbon-based silicon-doped material; and the third conductive agent comprises the second functional material and at least one of conductive carbon black, acetylene black, Ketjen black, conductive graphite, conductive carbon fiber, metal powder, or carbon fiber.

18. The negative electrode plate according to claim 15, wherein the third active substance comprises silicon-doped graphite; the third conductive agent comprises conductive carbon black and carbon nanotubes; and the third binder comprises styrene-butadiene latex.

19. The negative electrode plate according to claim 8, wherein the first sub-active layer, the second sub-active layer, and the third sub-active layer have a same thickness; or
a thickness of any layer of the second sub-active layer and the third sub-active layer is less than a thickness of the first sub-active layer; or
a thickness of the third sub-active layer is less than a thickness of the second sub-active layer, and the thickness of the second sub-active layer is less than a thickness of the first sub-active layer.

20. A battery, comprising the negative electrode plate according to claim 1.
